(19) United States
(12) Patent Application Publication
(10) Pub. No.: US 2003/0165057 A1
(43) Pub. Date: Sep. 4, 2003

(54) Leading wire arrangement of a lighting fixture in a back light module

(75) Inventors: Wen-Yuan Cheng, Taoyuan Hsien (TW); Chi-Chih Chu, Taipei Hsien (TW)

Correspondence Address: BRUCE H. TROXELL, SUITE 1404, 5205 LEESBURG PIKE, FALLS CHURCH, VA, 22041, US

(73) Assignee: AU Optronics Corporation

(21) Appl. No.: 10/349,927

(22) Filed: Jan. 24, 2003

(30) Foreign Application Priority Data
Mar. 1, 2002 (TW) 091103726

(51) Int. Cl. H01R 33/00

(52) U.S. Cl. 362/226

(57) ABSTRACT

A leading wire arrangement in a lighting fixture with back light module provides a set of connecting wire led from the lighting fixture to a rear side of the back light module via a lateral wall of the back light module.

### BACKGROUND OF THE INVENTION

1. Field of the Invention

The present invention relates to a leading wire arrangement of a lighting fixture in a back light module.

2. Description of Related Art

The liquid crystal display (LCD) is popularly adopted in electronic or information industry and the principle of the LCD is in that a back light module is installed in the LCD and the back light module includes a back light plate and a lighting fixture or a light source, which usually is a light tube, to display luminously. The back light module is attached to a PDA, a notebook computer, a VCD, a DVD or any other image display.

Accordingly, the lighting fixture of the back light module basically has to be used with an external power source. Hence, connecting wires have to be led out after the lighting fixture being mounted to the back light module while the back light module is made. Further, a terminal has to be prepared in advance for being possible to take the electricity during the back light module being in use.

A conventional leading wire of the lighting fixture in the back light module is as shown in FIG. 1 and the corner of the back light module A extends a connector B. The connector B with the connecting wires C and a lighting fixture, i.e., a light tube are lined up so that the soldered spots between the connector B and the connecting wires C may become loose in case of the connector B being pulled with a linear drag force. If the drag force is over vigorously pulled, it is possible to break the connecting wires C. Besides, as the forgoing, the back light module A has to be mounted on an another product such as a notebook computer so that the frame part of the notebook computer has to be restricted by the connector B and the connecting wires extending from the lateral side of back light module A and both the design and layout of the subsequent product are affected unfavorably.

### SUMMARY OF THE INVENTION

The crux of present invention is to provide a leading wire arrangement of a lighting fixture in a back light module, which provides a set of connecting wires led from the lighting fixture to a rear side of the back light module via a lateral wall of the back light module.

### BRIEF DESCRIPTION OF THE DRAWINGS

The present invention can be more fully understood by reference to the following detailed description and accompanying drawings, in which:

FIG. 1 is a perspective view illustrating a conventional way of the electrical wires of a lighting fixture in a back light module being lead out; and

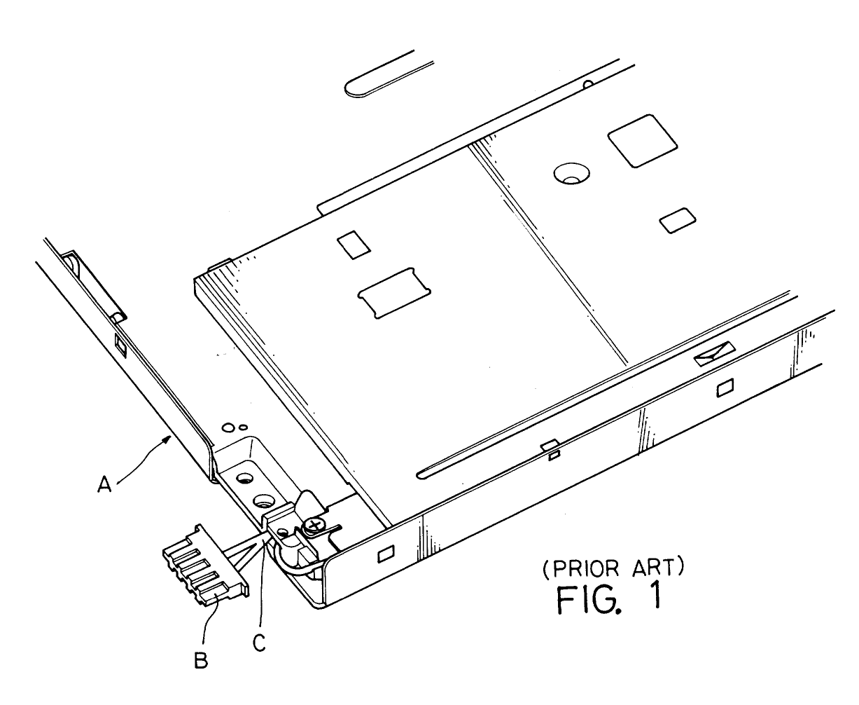

FIG. 2 is a perspective view illustrating the electrical wires of a lighting fixture in a back light module according to the present invention being lead out.

### DETAILED DESCRIPTION OF THE PREFERRED EMBODIMENTS

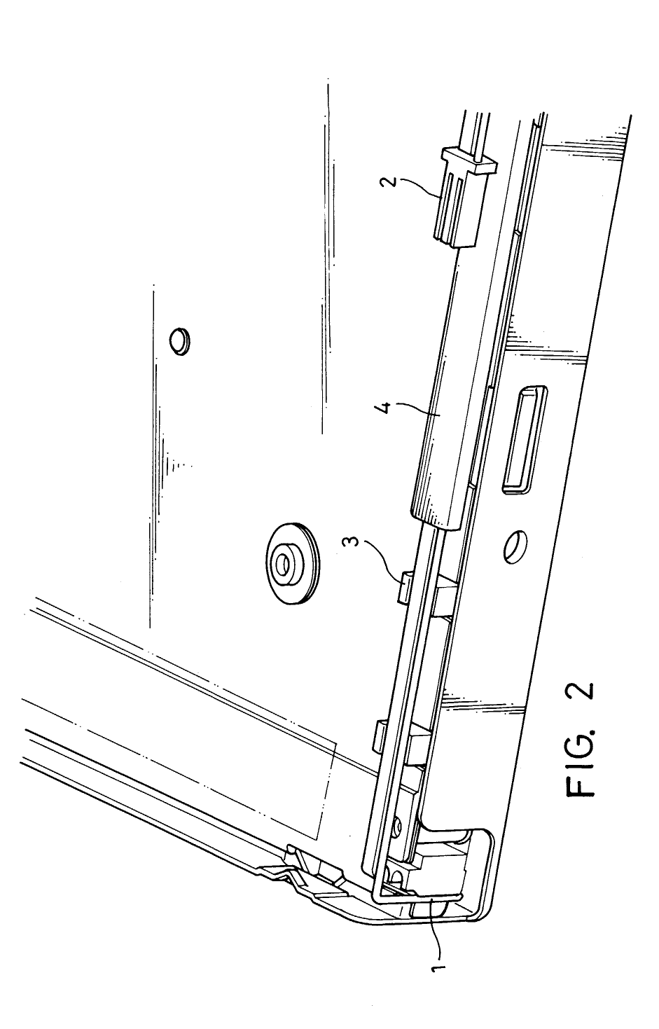

Referring to FIG. 2, basically, a wire leading arrangement of a lighting fixture in a back light according to the present invention comprises a set of connecting wires 1, a connector 2, at least a grip base 3 and and/or a heat shrunken jacket 4.

Wherein, the connecting wires 1 are associated with a lighting fixture (not shown) and at the end part thereof is connected to the connector 2. It can be seen that the connecting wires 1 are led from a corner of a back light module and then bypass the edge part thereof, i.e., the lateral wall thereof. Finally, the connecting wires 1 further extend along the back of the module so as to be disposed on the back of the module via a turn.

The connector 2 is disposed at the end part of the connecting wires 1 for being inserted with the external power source. It is noted that the connector 2 is belonged to the prior art and no detail will be described further.

The grip base 3 is provided on the frame of the module for holding the connecting wires 2 and slightly stretching the connecting wires 2. In case of the connector being pulled, the grip base 3 can mitigate the pulling force moderately so as not to drag violently the connecting wires 1 at a section part thereof next to the end of lighting fixture.

The heat-shrunken jacket 4 is covering tube enclosing the connecting wire 1. Because the heat-shrunken jacket 4 is also belonged to the prior art, no detail will be described further.

Referring to FIG. 2 again, the power source of the lighting fixture can be obtained via the connector 2 of the back light module and the corner of the wall edge is not attached with a section of wires and a connector while the lighting fixture is continuously used so that the design of the lighting fixture becomes much more flexible due to no jutting out part. Meanwhile, once the connector 2 is pulled with a drag force, it is not easy for the soldered conjunction of the connecting wires 1 and lighting fixture to become separate so that the undesirable phenomenon with regard to the connecting wires being detached from the soldered junction can be eliminated effectively.

While the invention has been described with reference to a preferred embodiment thereof, it is to be understood that modifications or variations may be easily made without departing from the spirit of this invention, which is defined by the appended claims.

What is claimed is:

1. A leading wire arrangement of a lighting fixture in a back light module, providing:
a set of connecting wires, being led from the lighting fixture to a rear side of the back light module via a lateral wall of the back light module.

2. The leading wire arrangement in a lighting fixture with back light module according to claim 1, wherein an end of the connecting wires may added with a connector for being inserted with an external power source.

3. The leading wire arrangement in a lighting fixture with back light module according to claim 2, wherein the rear side of the module provided with at least a grip base for holding the connecting wires passing the rear side of the module.

4. The leading wire arrangement in a lighting fixture with back light module according to claim 2, wherein the connecting wires at the rear side of the module can be enclosed with a heat-shrunken jacket.

5. A back light module, comprising
a lateral wall, being for a connecting wire led from the lighting fixture outward;
a rear side, covering component parts forming the module;
a lighting fixture, being fixedly attached to the rear side below a bottom part thereof; and
a set of connecting wires, being let from the lighting fixture and reaching the rear side via extending upward along a lateral wall of the module.

6. The back light module according to claim 5, wherein the connecting wires are a positive wire and a negative wire.

7. The back light module according to claim 5, wherein an end of the connecting wires may be added with a connector.

8. The back light module according to claim 5, wherein the rear side is provided with at least a grip base for holding a led part of the connecting wires.

9. The back light module according to claim 5, wherein the connecting wires at a section passing the rear side can be enclosed with a heat-shrunken jacket.
